(19) United States
(12) Patent Application Publication
(10) Pub. No.: US 2009/0196038 A1
(43) Pub. Date: Aug. 6, 2009

(54) LED LAMP FOR STREET LIGHTING

(76) Inventor: Laura Patricia Vargas Maciel, Jalisco (MX)

Correspondence Address: CHARLES W. HANOR, P.C., 750 Rittiman Road, SAN ANTONIO, TX, 78209, US

(21) Appl. No.: 12/294,366

(22) PCT Filed: Feb. 12, 2007
(86) PCT No.: PCT/MX2007/000012

§ 371 Date: Sep. 24, 2008

(51) Int. Cl. F21V 21/00; F21V 33/00

(52) U.S. Cl. 362/249.03; 362/234; 313/45

(57) ABSTRACT

The present invention refers to a lamp for public lighting system that works with high power LEDs, for the direct substitution of the present sodium vapour or metal halides lamps, using the same light fixtures OV type and/or similar with an integrated power supply and a standard socket Mogul-39 or Edison-39. And that improves substantially my previous invention WO2008100124 as far as the cost of manufacture and easiness of assembly, better luminance distribution; lower operating temperature and more lumens per watt, besides to be prepared for the new generations of LEDs. Characterized by having a standard electrical connector that allows the lamp to be coupled any type of street light fixtures or luminaries; a base within it has a connector to couple it into a dissipating ring that has external and internal teeth to dissipate the heat generated by a power supply used to regulate and to convert the originating electrical energy of the network; a cover to close to the dissipating ring and to protect the electronic board. The Lamp of high power LEDs has a heat dissipating platform equipped with heads with external and internal teeth, and wall-bases that also are used to dissipate the heat generated by the high power LEDs when they operate; finally the lamp of high power LEDs has a single protective lens to direct the light emitted by the LEDs in a distribution very similar to the type I that is considered to be optimum for the illumination of streets and avenues giving therefore a greater pole to pole distance between the lights.

### TECHNICAL FIELD

The present invention has its technical field in the electricity, the mechanics and in optics since it provides an improvement to the lamp that works with high power LEDs, now broadly used in many lighting systems.

### BACKGROUND OF THE INVENTION

As is known, the present technology for the public lighting system mainly uses sodium vapour or metal halides in its devices with which the consumption of electric energy with respect to incandescence has been reduced considerably, although is possible to mention that lost of quality in the light it has had, since this is yellow and of a poor quality. It is for that reason that in the last years there has been a development of lamps made from LEDs which they emit white light and use gallium and phosphorus (white LED of high power). Some examples of patents of lamps and lights that work with LEDs are: JP 20010248020; JP20010248019; JP 20030086591; JP 19960292469; JP 20040115720; JP 20010253738; EP 20040008529 and IS U200501 645; but without a doubt the most important example is my patent presented in Mexico under the number WO2008100124 on Jan. 8^{th}, 2007 of which I am presenting a substantial improvement in this document. These patents are characterized because they have diverse types of chassis, square or polar housings, arrays of LEDs, that when mounted in electronic boards can be integrated into modules, use diverse designs of reflecting surfaces of light emitted by the LEDs, have optical systems, lenses or different types of reflectors to distribute the light wider, heat dissipaters and regulators of temperature also are used, and although they fulfill their requirements usually they are too hindering, heavy and expensive.

On the other hand in most of these cases, they have not been using high power LEDs that emit a luminous flux considerably greater than traditional LEDs.

Being a fundamental need the reduction of energy consumption, that in this case can be of up to 80% of savings compared with the present systems of sodium vapour, realizing the fact that almost 80% of our electrical energy comes from the fossil fuels combustion. In addition to that, there is an urgent need to stop the green house effect caused by the global warming.

### DETAILED DESCRIPTION OF THE INVENTION

The characteristic details of the high power LEDs lamp are clearly shown in the following description and in the figures that are attached, where the substantial improvements to my previous model presented under the patent number WO2008100124 on Jan. 8^{th}, 2007 as well as a detailed illustration of those, following the same references to indicate the improved parts, which are mentioned to exemplify and they do not have to be considered like limitative to the present invention.

### FIGURES DESCRIPTIONS

FIG. 1 illustrates a view in explosive perspective of the LEDs high power lamp.

FIG. 2 is a perspective view of the lamp of high power LEDs assembled together.

FIG. 3 illustrates a superior view of the lamp of LEDs of high power assembled.

FIG. 4 shows a lateral view of the left being substantially equal to the right view, of the lamp of LEDs of high power assembled.

FIG. 5 illustrates a frontal view of the lamp of high power LEDs assembled.

FIG. 6 is a perspective view of the electrical connector and the base of the high power LEDs lamp.

FIG. 7 illustrates a superior view of the electrical connector and the base of the high power LEDs lamp.

FIG. 8 is a lateral view of the electrical connector and the base of the high power LEDs Lamp.

FIG. 9 illustrates a frontal view of the electrical connector and the base of the high power LEDs lamp.

FIG. 10 is a perspective view of the heat dissipating ring of the high power LEDs lamp.

FIG. 11 is a superior view of the dissipating ring of the high power LEDs lamp.

FIG. 12 illustrates a lateral view of the dissipating ring of the high power LEDs lamp.

FIG. 13 is a frontal view of the dissipating ring of the high power LEDs lamp.

FIG. 14 is a frontal perspective view of the cover of the lamp of LEDs of high power.

FIG. 15 is a lateral view of the cover of the high power LEDs lamp.

FIG. 16 is a perspective view of the dissipating platform of the high power LEDs lamp.

FIG. 17 illustrates a superior view of the dissipating platform, with the aluminium card of LEDs, of the high power LEDs lamp.

FIG. 18 is a lateral view of the dissipating platform of the high power LEDs lamp.

FIG. 19 illustrates a frontal view of the diffusing platform of the high power LEDs lamp.

FIG. 20 is a perspective view of LEDs, the aluminium card and the protective lens of the high power LEDs lamp.

FIG. 21 illustrates a superior view of the aluminum plate where the 28 LEDs, the protective lens and its packing of high power LEDs lamp go mounted.

FIG. 22 is a lateral protective view of the lens of the high power LEDs lamp.

FIG. 23 illustrates a frontal protective view of the lens and the plate of lenses of the high power LEDs lamp.

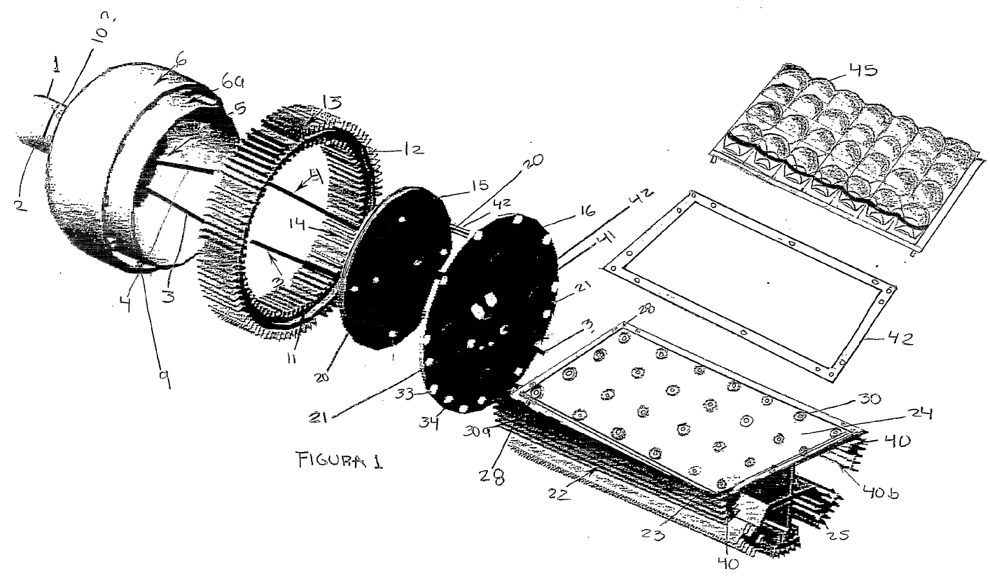

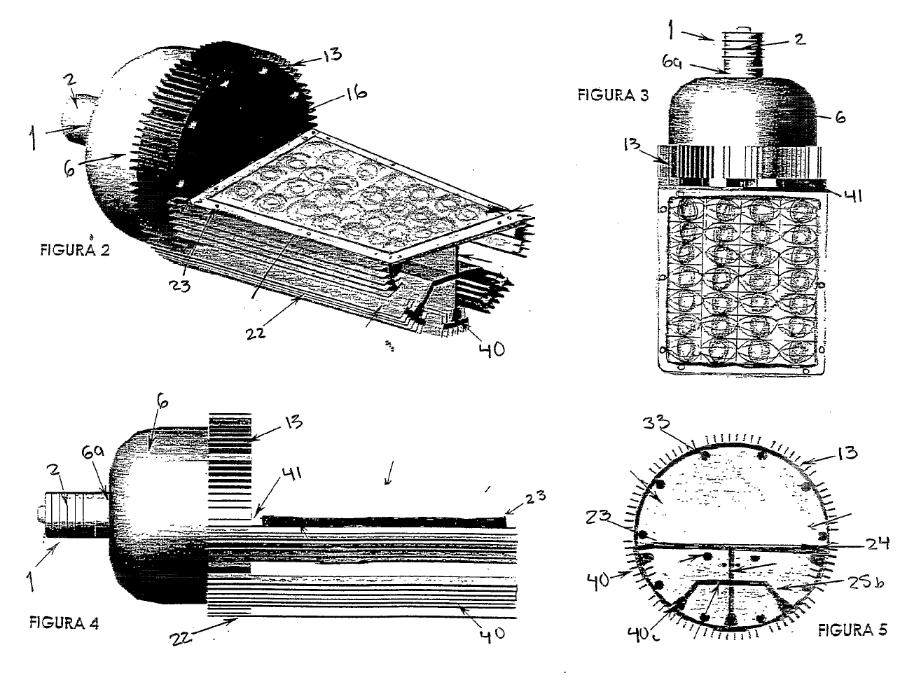

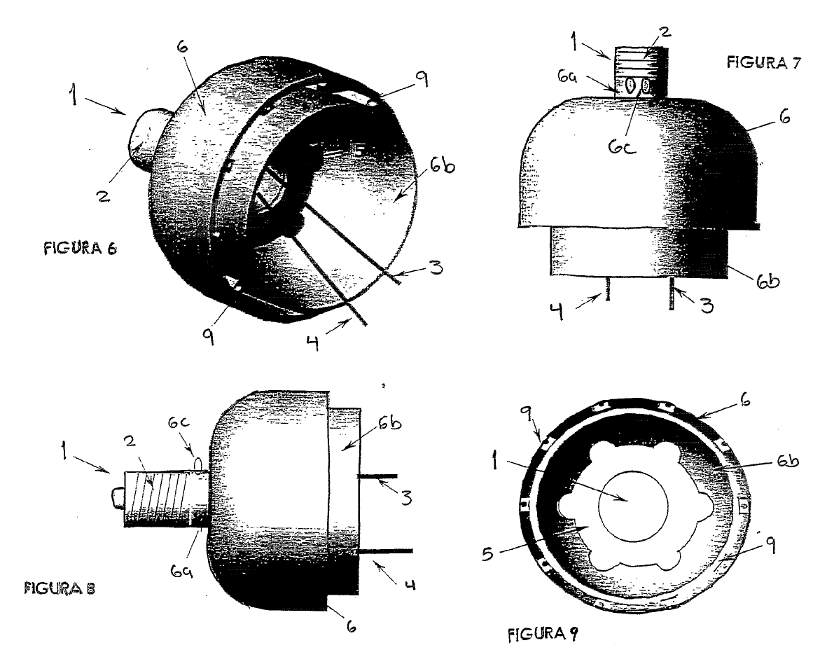

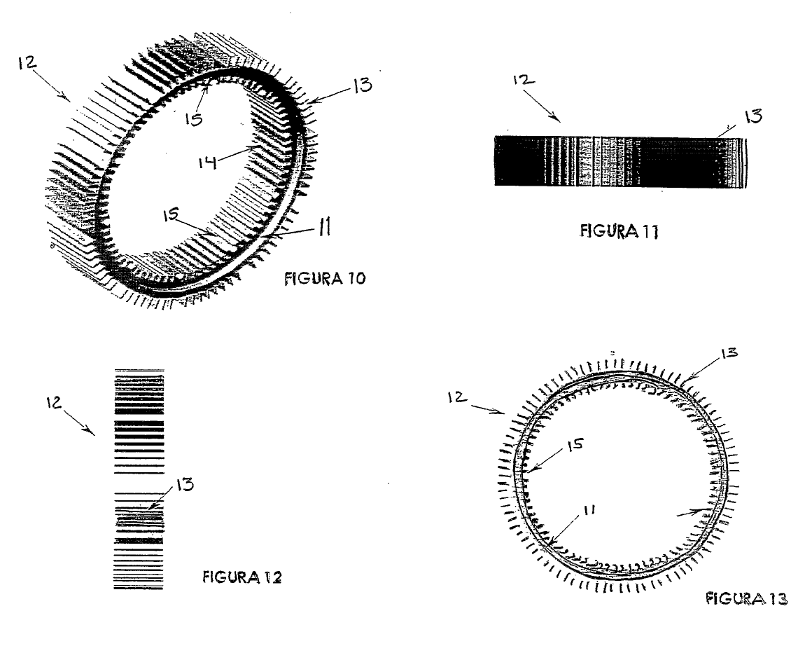

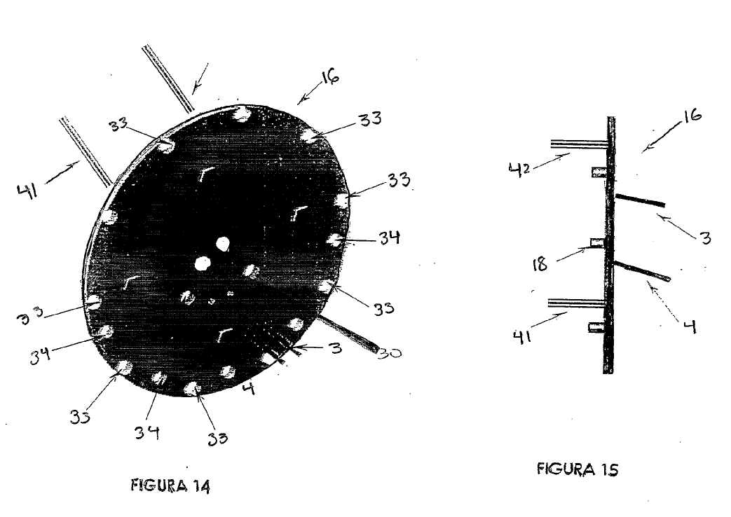

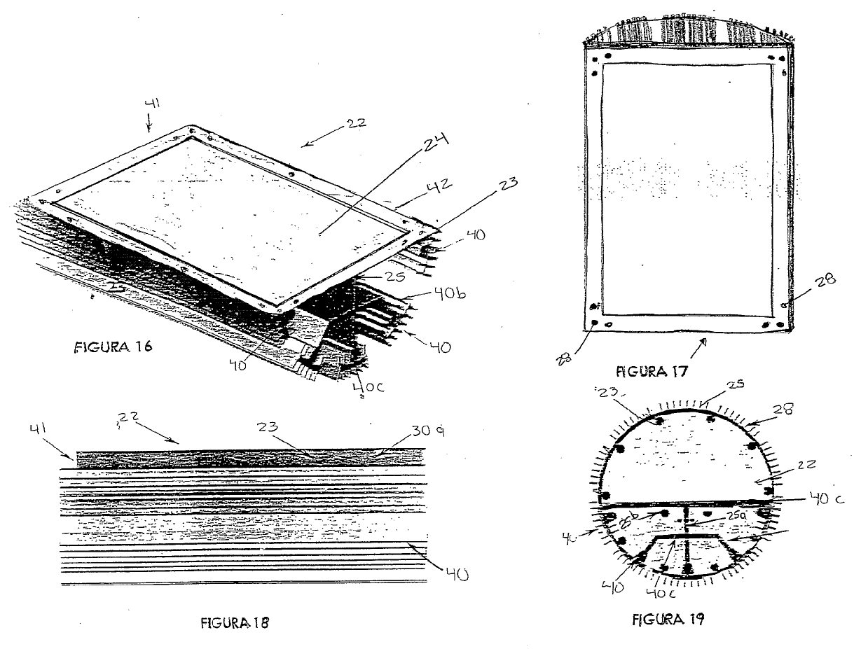

In reference to these figures, the high power LEDs lamp is constituted by:

a) An electrical “standard” connector (1), Mogul E-39 type which is formed by a spiral socket (2), that in one of his ends, has a metallic end, used to make electrical contact itself within the “socket” or female connector of the lights and thus to feed the high power LEDs lamp with originating energy of the network of power supply that could be of 80 to 265 volts of alternate current. Inside the spiral socket (2), from the metallic end, there is derived: a cable with the current (3), and a neutral cable (4), that are connected on the same way to the power supply that is an electronic switching power supply where an electronic card acts to convert the electrical power to DC. The other end of the electrical connector (1), have on a handle (5), that helps to assemble it to the inside of;

b) A base (6), made of plastic, that gives body to the high power LEDs lamp and is similar to a half sphere that is formed by: a first orifice where is assembled a first cylindrical connector (6a), which has a pair of tops, next to each other, located in its external face so that the base (6), can turn within a ring positioned when the lamp settles. The end of the electrical connector (1), that has the handle (5), holds it as it were said before, inside this base (6). A second orifice formed by the located semi cylindrical cavity inside the base (6) has in its perimeter petitioners 9), distributed radially and equidistant to each other, equipped each one with a threaded large drill, that has the function of connecting itself ahead with the connectors of the described dissipating ring, and at the same time they help to maintain the attachment to a second hollow cylindrical connector (6b), that extends from the interior of the base (6), outwards and has the purpose of being a coupler that is introduced ahead inside the described dissipating ring;

c) a positional ring (10) that is made of plastic, has two blocking stops, located in its internal face (10), that make contact with the external stops (6b), located in the first cylindrical connector (6a), of the base (6), when the lamp settles. The internal stops of the ring positional make contact with the external stops of the first cylindrical connector, to allow to the high power LEDs lamp to turn in both directions up to 180 degrees and to direct and position the lamp once t is installed, because the fixture's socket has a fixed position, in such a way that when the lamp settles it does not always direct its light in the desired direction due to this random condition of connection between the electrical connector (1), and the fixture socket;

d) the dissipating ring (12), is made of aluminium and has: a polar adjustment of “external teeth” (13), and “internal teeth” (14), formed by rectangular strips of aluminium used as the fins do in a condenser, dissipating the heat generated by the power supply and the high power LEDs ahead. Inside the dissipating ring (12), by its back face introduces the second hollow cylindrical connector (6b), connecting this way to the base (6), with this ring, that also has in its interior: drilled blocks (14), distributed and radially equidistant to each other, used to be coupled with the drilled thread of the positioners (9), located in the base (6). The frontal face of the dissipating ring (12), has a reduction (11), so that a cover is mounted as it is ahead detailed;

e) the power supply (15), as it was said before has an electronic board that receive electrical current from the positive (3) and neutral (4) cables, is similar to a disc in which there are distributed radially equidistant to each other, orifices used to screw it to the cover. This power supply (15); is located inside the dissipating ring (12), and has an electrical circuit to regulate and to turn to direct current the originating electrical energy of the network and to send it to the high power LEDs allowing them to operate; the heat that is generated during this process is dissipated by the external (13), and internal (14) teeth, of the dissipating ring (12);

f) the cover (16), is a disc that is coupled in the reduction (11), of the dissipating ring (12), and serves to protect and to mount on it the electronic board of the power supply (15), by screws mounted on the holes (18), with threaded large drills, distributed and radially equidistant to each other, in this way it is avoided that the board has a direct contact with the back of the cover (16), one that has: a first pair of all the way large drills (21), on the center used to introduce in each one of them the positive current (3) and neutral (4) cables, respectively originated on the electronic board so that they can go up to the high power LEDs, with the regulated and converted electrical energy so they can operate; a second pair of all the way large drills (20), also located in the center in which two cables (41) and (42) originated on the transistors located in the power supply are screwed (15), and helps to dissipate the heat generated by the mentioned diffuser ring (12); one first series of all the way large drills (33), distributed and radially equidistant to each other, in all their perimeter, these allows to screw it with the large drills of the “boxes” (15), of the diffusing ring (12), when these are reconciled; one second series of last (34), distributed radially and equidistant large drills to each other, located single in a half of the diameter of the cover (16), and is put in with the second series of last large drills (33), that serve to hold by means of screws to the cover (16), with;

f) the cover (16), is a disc that is reconciled in reduces (11), of the diffusing ring (12), serves to protect and to mount on her to the electronic card of the “source of being able” (15), by means of posts (18), with threaded large drills, distributed and radially equidistant to each other, in this way is avoided that the card between in direct bonding with the later face of the cover (16), which to his you see account with: a first pair of last large drills (21), in central zone used to introduce in each one of them cables current (3) and neutral (4), respectively originating of the electronic card so that they can arrive until high power LEDs, with the regulated and prepared electrical energy so that these can operate; a second pair of last large drills (20), also located in the central zone in which two cables (41) and (42) originating of the transistors located in the “source of being able” are screwed (15), and serves to dissipate the heat generated by such through diffusing ring (12); one first series of last (33), distributed and radially equidistant large drills to each other, in all their perimeter these allows him to screw it with the large drills of the “boxes” (15), of the dissipating ring (12), when they are coupled; one second series of all the way large drills (34), distributed radially and equidistant to each other, located single in a half of the diameter of the cover (16), that are combined with the second series of last large drills (33), that serve to hold with screws the cover (16), with;

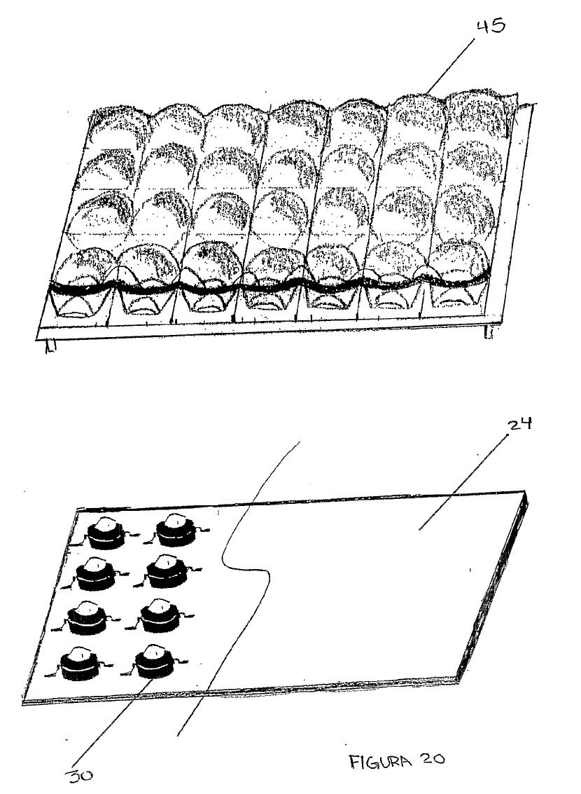

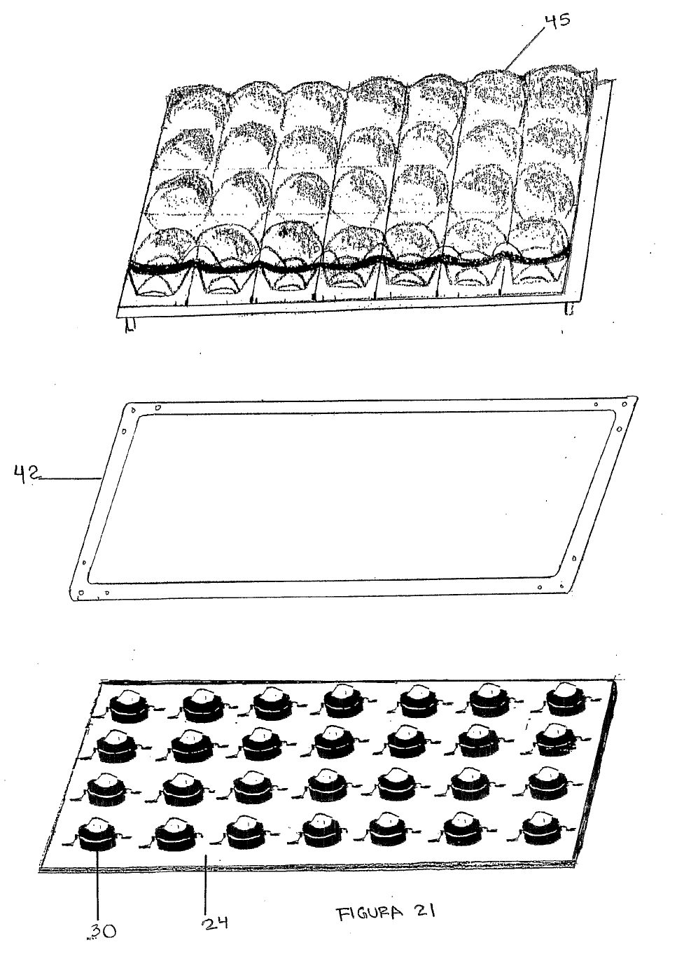

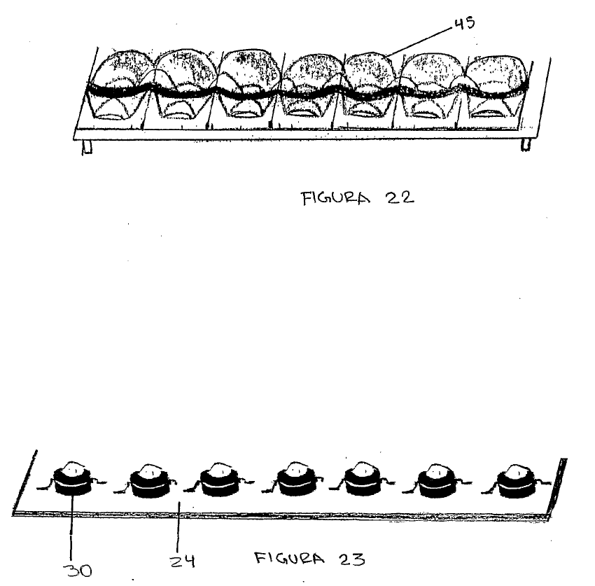

g) a dissipating platform (22), made of aluminium which is intends to dissipate the heat generated by the high power LEDs, formed by a major base of rectangular shape (23), and as can be seen clearly on FIG. 16, they serve to place on them the aluminium card where the welded high power LEDs are placed (24), that is basically a drilled aluminium card that is able to be screwed to the diffusing structure of aluminium and with large drills to be able to be connected to the power supply (3) (4), originated on the power supply to connect them to the high power LEDs (30). This major base (23), has in their surface equidistant and distributed al the way large drills, that have a rectangular array with the centers of the large drills of the LEDs board (28), so that they can be screwed. In the center the major baser (23) and (24), converges the upper end of a third rectangular base (25), that works as a support from which a pair of perpendicular rectangular fourth bases (25a) come off, approximately in the middle of his height, which are followed each one by a fifth rectangular base (25b), one that is bended, so that the rectangular bases fourth and fifth (25a) and (25b), respectively form an internal angle and are similar to two ramifications as it is seen in FIG. 19, that help to have body and rigidity to the lamp but mainly to dissipate the generated heat. It is possible to mention that the major base (23), the third rectangular base (25), and the fifth bases (25b), are equipped in each of their ends with a “head” (40), which is formed by the section of a longitudinally cut hollow cylinder in whose outer face are located perpendicular to this section of the cylinder, rectangular aluminium strips whose next parallel bars extend to each other and, are similar to the “teeth” of a gear. Each “head” (40), has in its inner face “teeth” (40b), and wall-plates (40c), formed by semi-square solid prisms, which have large drills threaded in their later faces so that the dissipating platform (22), can be screwed in the second series of last large drills (34), of the cover (16), at the same time that helps in the dissipation of the heat. Optionally the greater plates (23) and (24) can have a reduction (41), in their back face, where they are coupled with the cover (16), that works like an exit to dissipate the heat generated by the high power LEDs;

h) An electronic aluminum board that is denominated PCB (24), where the welded high power LEDs (30) are positioned and it is screwed to the major base and between these two we have heat transmitter mean for its correct thermal coupling;

i) the protective lens (45), of polycarbonate that acts to protect the LEDs and to give a correct distribution of the light radiation as it is required in the lighting systems, has large drills as well to be screwed in the rectangular bases (23) and (24), of the dissipating platform and a rubber packing (42) to avoid humidity filtrations also used to direct the light emitted by the high power LEDs. The number of the high power LEDs (30), may vary according to the users requirements. In this example we are showing an array of 28 LEDs.

Main advantages of the high power LEDs lamp for lighting system I publish:

1.—Its main advantage is without a doubt the low consumption, 80% less electrical energy than those of sodium vapour or metal halides.
2.—More than 100.000 hours of life.
3.—Low cost of maintenance.
4.—It is 100% repairable at a low cost, they are never discarded, just repaired.
5.—High replaceability, because it is possible to be installed in any type of lighting fixtures or luminaries, because of its dimensions and the standard electrical connector, as a common bulb.
6.—Extremely low consumption of electric energy in comparison to the consumption of the sodium vapour or metal halides lamps, or any other present system of public lighting.
7.—Lower heat generation, more luminosity, lower cost of manufacture on the lenses, more efficient LEDs of 1 watt instead of 5 watt, compared with my previous design.
8.—Has heat dissipators: ring and platform that extend the usage life of the high power LEDs.
9.—Emits white light of better quality than the poor yellow light used by the sodium vapour lamps at the present time.
10.—Does not emit ultraviolet and infrared light, so it does not attract insects which reduces substantially its maintenance.
11.—It has more than 2.000 lumens so this means a high level of luminosity.
12.—Easy assembly and production.
13.—Easy maintenance
14.—Reduced number of components.
15.—High efficiency in relation to its power and luminosity (80 lumen/watt approx).
16.—Possibility of installing a bigger number of LEDs of different characteristics and colours increasing or diminishing the amount of lumens.
17.—Its design is prepared for the installation of new generations of LEDs that will be up to 200 lumens/watt.

1. (canceled)

2. (canceled)

3. An LED based lighting fixture for street lighting, comprising:
a connector connecting the lighting fixture to a lighting socket of a street light, the connector providing an electrical connection for receiving power from the lighting socket and providing mechanical support for suspending the lighting fixture;
a base, attached to the connector, housing a power supply unit receiving power from the lighting socket via the connector and converting the power into a desired state for powering an LED array;
a substantially flat LED array including a plurality of LEDs mounted to a first side of an LED board, attached to the base such that the array projects outwardly from the base, perpendicular to a circumference of the base; and
a diffuser structure attached to a second side of the LED board, opposite to the first side of the LED board, the diffuser structure being substantially semi-cylindrical having a flat side and an arced side, the flat side being attached to the second side of the LED board,
wherein the base is attached to the connector such that the connector can rotate relative to the base, LED board and diffuser, for a limited travel distance in both a clockwise and counter clockwise direction such that the rotational orientation of the LED board remains adjustable for the limited travel distance, after the connector is securely connected to the lighting socket.

4. The lighting fixture of claim 3, wherein the connector is threaded for screwing into the lighting socket.

5. The lighting fixture of claim 3, additionally comprising a diffuser ring attached to the base for dissipating heat that is generated nu the power supply unit housed within the base.

6. The lighting fixture of claim 5, wherein the diffuser ring is in thermal contact with the diffuser structure.

7. The lighting fixture of claim 3, additionally comprising a positioning ring, fixedly connected to the connector and rotatably connected to the base, for allowing the base, LED board and diffuser to all rotate relative to the connector, for a limited travel distance in both a clockwise and counter clockwise direction such that the rotational orientation of the LED board remains adjustable for the limited travel distance, after the connector is securely connected to the lighting socket.

8. The lighting fixture of claim 3, wherein the plurality of LEDs project light substantially perpendicularly to the plane of the flat LED array.

9. The lighting fixture of claim 3, additionally comprising a single lens covering the flat LED array, attached to the diffuser, and directing light projected from all of the plurality of LEDs.

10. The lighting fixture of claim 3, wherein the diffuser structure includes a main plate comprising its flat side for drawing heat from the LED board and one or more projections emanating from the main plate for drawing heat from the main plate, the ends of the one or more projections forming the arced side of the substantially semi-cylindtical diffuser structure.

11. The lighting fixture of claim 10, wherein at least one of the one or more projections is branched.

12. A diffuser structure for an LED lighting fixture, comprising:
a diffuser platform, made of aluminum, for dissipating heat generated by one or more LEDs attached thereto;
a plurality of aluminum projections extending from the diffuser platform and each having an aluminum head at its end, the outer surface of the heads forming an arched surface that gives the diffuser structure a semi-cylindrical shape, wherein one or more of the aluminum projections branches, with each branch having a corresponding aluminum head; and
a substantially cylindrical ring-diffuser attached to an end of the diffuser platform and aligned thereto such that the ring-diffuser and the outer surface of the plurality of aluminum heads share a common axis and radius.

13. The diffuser structure of claim 12, wherein the diffuser platform has a substantially rectangular shape.

14. The diffuser structure of claim 12, wherein the diffuser platform includes one or more ridges for added structural support.

15. The diffuser structure of claim 12, wherein the outer surface of the heads have teeth formed of aluminum strips.

16. The diffuser structure of claim 12, wherein the inner surface of the heads have teeth formed of aluminum strips.

17. The diffuser structure of claim 12, wherein the one or more LEDs are attached to the diffuser platform as part of an LED array circuit board.

18. The diffuser structure of claim 12, wherein the one or more LEDs project light substantially perpendicularly to the plane of the diffuser platform.

19. The diffuser structure of claim 12, wherein the ring-diffuser is in thermal contact with a power supply unit for supplying power to the LEDs and the diffuser platform is in thermal contact with the LEDs.

20. The diffuser structure of claim 12, additionally comprising a single lens covering the LEDs, attached to the diffuser platform, and directing light projected from all of the LEDs.

21. The diffuser structure of claim 12, wherein the diffuser platform and the plurality of aluminum projections form a substantially hollow semi-cylinder.

22. An LED based lighting fixture for street lighting, comprising:
a connector connecting the lighting fixture to a lighting socket of a street light;
a base, attached to the connector, housing a power supply unit supplying power for powering an LED array;
an LED array including a plurality of LEDs mounted to an LED board, attached to the base such that the array projects outwardly from the base, perpendicular to a circumference of the base; and
a diffuser structure attached to the LED board, the diffuser structure being substantially semi-cylindrical having a flat side and an arced side, the flat side being attached to the second side of the LED board,
wherein the base is attached to the connector such that the connector can rotate relative to the base, LED board and diffuser, for a limited travel distance in both a clockwise and counter clockwise direction such that the rotational orientation of the LED board remains adjustable for the limited travel distance, after the connector is securely connected to the lighting socket, and
wherein the diffuser structure includes:
a diffuser platform, made of aluminum, for dissipating heat generated by the LED board;
a plurality of aluminum projections extending from the diffuser platform and each having an aluminum head at its end, the outer surface of the heads forming an arched surface that gives the diffuser structure a semi-cylindrical shape, wherein one or more of the aluminum projections branches, with each branch having a corresponding aluminum head; and
a substantially cylindrical ring-diffuser attached to an end of the diffuser platform and aligned thereto such that the ring-diffuser and the outer surface of the plurality of aluminum heads share a common axis and radius.
